(19) United States
(12) Patent Application Publication
(10) Pub. No.: US 2002/0016751 A1
(43) Pub. Date: Feb. 7, 2002

(54) Experimental information exchanging system

(76) Inventor: Kazuma Sekiya, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/917,629

(22) Filed: Jul. 31, 2001

(30) Foreign Application Priority Data
Aug. 3, 2000 (JP) 2000-235757

(51) Int. Cl. G06F 17/60

(52) U.S. Cl. 705/26

(57) ABSTRACT

Disclosed is an experimental information exchanging system using terminal devices connected to a computer communication system permitting a purchaser and a manufacturer to exchange the experimental information. The experimental information includes at least experimental contents, preparation items required for a given experiment and pieces of information pertaining to the development of the experiment. The experimental information is presented on the monitor display each of the terminal devices, thereby permitting the purchaser and the manufacturer to discuss on the experiment on the basis of the experimental information presented on the display each of the terminal devices.

### BACKGROUND OF THE INVENTION

1. Field of the Invention

The present invention relates to a communication system permitting to a purchaser and a manufacturer to exchange pieces of information pertaining to an experiment which the manufacturer carries out on a machining apparatus similar to the one bought and owned by the purchaser.

2. Related Arts

Assuming that a purchaser has bought a machining apparatus from a firm making and selling machining apparatuses, and that the purchaser finds that the machining apparatus lacks a desired function, or is unable to perform a required machining, the purchaser asks the manufacturer to carry out an experiment to meet the requirements.

The purchaser requests the manufacturer to carry out a required experiment by filling in a form of experiment request, giving the purchaser's name, the kind of an extra workpiece which cannot be machined, etc, and by sending the filled-in form to the manufacturer. Then, an expert who works for the manufacturer carries out the experiment as requested in the form.

In the course of the experiment there may occur some troubles or difficulties to prevent further development of experiment, and the expert must find out how to reduce such troubles or difficulties. In the hope of finding out the answer the expert consults with the purchaser about the difficulties which he has encountered over the telephone. Telephone conversation, however, is often the cause for trouble with the result that the experimental report fails to meet the purchaser's demand.

Confirmation by facsimile may be effective to avoid such undesired result, but facsimile letters often fail to reach the purchaser. Insufficient interchange between the purchaser and the manufacturer will provide unsatisfactory experiment.

In a case where two or more experiments are carried out on similar subjects simultaneously, communication by telephone or facsimile may cause confusion on both sides.

Quick, reliable communication between the purchaser and the manufacturer, therefore, is a matter of great concern in improving the reliability with which the experiment can be carried out.

### SUMMARY OF THE INVENTION

In view of the above an experimental information exchanging system using terminal devices connected to a computer communication system permitting a purchaser and a manufacturer to exchange the experimental information, is improved in that the experimental information includes at least experimental contents, preparation items required for a given experiment and pieces of information pertaining to the development of the experiment; and that the experimental information is presented on the monitor display each of the terminal devices, thereby permitting the purchaser and the manufacturer to discuss on the experiment on the basis of the experimental information presented on the display each of the terminal devices.

The experimental information presented on the monitor display may include, in the form of titled blanks, the name of the purchaser, the name of the manufacturer, the day on which the purchaser asked the manufacturer to carry out a required experiment, the theme of the experiment, the day on which the experiment is scheduled to start or the experiment is made to start, the day on which the experiment is scheduled to end or the experiment is finished, the table of experiment schedule, problems to be solved, the method of solving such problems and the report on the experimental development; and the purchaser or the manufacturer writes in selected blanks, and reads out the required pieces of information from the so filled blanks, thereby permitting the purchaser or manufacturer to make a required confirmation on the monitor display.

Photographs, drawings and/or experimental data may be attached to the experimental information.

The computer communication system may be an Internet, and the experimental information may be stored in the server.

With the arrangement the purchaser and the manufacturer can have one and same experimental information table in common, so that they can discuss about the experiment in development while watching the table presented in the display.

While developing the experiment, the manufacturer can write in the experimental information table to describe how far the experiment has been developed, and when the manufacturer has encountered some difficulties in experiment, he can consult with the purchaser by describing such experimental difficulties in the experimental information table.

Other objects and advantages of the present invention will be understood from the following description of an experimental information exchanging system according to one preferred embodiment of the present invention.

### BRIEF DESCRIPTION OF THE DRAWING

FIG. 1 illustrates an experimental information exchanging system according to the present invention; and

FIG. 2 shows a form of experimental information table.

### DETAILED DESCRIPTION OF PREFERRED EMBODIMENT

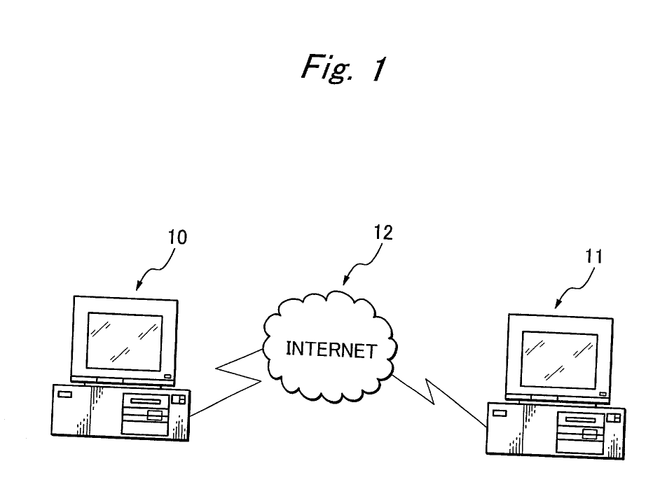

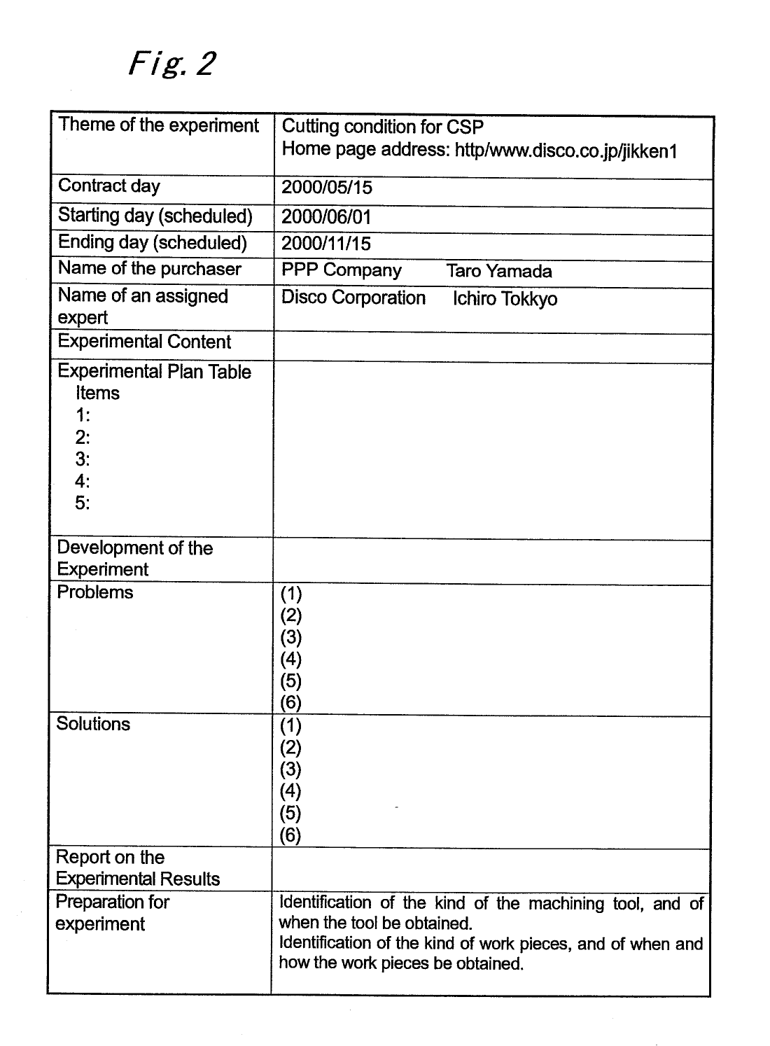

Referring to FIGS. 1 and 2, an experimental information exchanging system according to the present invention uses terminal devices such as personal computers 10 and 11 connected to a computer communication system such as an Internet 12. The personal computer 10 is owned by a manufacturer, Disco Corporation (hereinafter abbreviated as “Disco”) who is making machining apparatuses whereas the personal computer 11 is owned by a purchaser, PPP Company (hereinafter abbreviated as “PPP”). It is assumed that the purchaser, PPP asks the manufacturer, Disco to carry out an experiment using a cutting apparatus.

A format of experimental information table 20 (see FIG. 2) is stored in a characteristic address on a WWW server of the Internet, permitting the purchaser and the manufacturer to access to the experimental information table 20, which is assigned an address that identifies the location, for instance, “http//www.disco.co.jp/jikken1”. The experimental information 20 can be checked by the personal computers 10 and II reading out and showing on the display via Internet. Entry of new data or correction of selected data in the experimental information table can be performed by using keyboards or mice.

In a case where the purchaser requests the manufacturer to carry out two or more experiments simultaneously, the parallel experiments may be distinguished in terms of different addresses assigned to them. Any third party may be prevented from accessing to the experimental information table simply by using passwords.

Referring to FIG. 2, the first, second, third, fourth, fifth and sixth blanks in the left column of the table are titled “theme of the experiment”, “day on which the purchaser asked the manufacturer to carry out a required experiment” (or “contract day”), “day on which the experiment is scheduled to start or the experiment is made to start” (or “starting day”), “day on which the experiment is scheduled to end or the experiment is finished” (“ending day”), “name of the purchaser”, and “name of the manufacturer” (or “name of an assigned expert”). The “theme of the experiment” is, for instance, determination of cutting condition most appropriate for dicing chip-sized, packaged substrates with the cutting machine bought from Disco. The second, third, fourth and fifth blanks are filled with specific dates, and the name of the purchaser and the name of the person in charge by using the personal computer 11.

In compliance with the request for experiment, Disco plans some details of the experiment, determining and writing the starting date and finishing date (Jun. 1, 2000 and Nov. 15, 2000) in the information table format. Also, Mr. Ichiro Tokkyo of Disco is written in the blank which is titled “the name of an expert” in the table.

The expert in charge writes some kind of tools and work pieces in the blank which is titled “preparation for experiment”, making a note of where and when such tools or work pieces shall be obtained. If PPP should find that the tools or work pieces selected by the expert in charge are not appropriate for the purpose, the purchaser informs the expert of that, preventing the execution of experiment by using such improper tools or work pieces.

The expert describes the experimental manner and condition in the blank, which is titled “Experimental Content”. For instance, the expert describes what kind of cutting tools are appropriate for the purpose of dicing CSP substrates; at what rate per unit time the machining water is supplied etc,. The expert can add additional experimental items to the blank of “Experimental Content”. Also, he can correct misunderstandings committed on the side of Disco, if any. This sort of correction, however, may be preferably made by telephoning.

On the basis of the “Experimental Content” with which the purchaser agrees, the expert plans the experiment in detail, and he fills the blank titled “Experimental Plan Table”, as for instance, follows: the kinds of cutting tools and work pieces are specified; some machining water feeding rates per unit time are identified; combinations of selected cutting tools and water feeding rates per unit time are given; and so forth.

After surveying the “Experimental Plan Table”, the purchaser can discuss with the expert about additional experimental items, if any. Such extra items may be proposed for expert's attention by using the purchaser's personal computer 11. Thus, the experiment can be carried out on the side of the manufacturer to meet purchaser's request all the time.

While carrying out the experiment, the expert can write in the experimental information table, particularly the blank of “Development Report” to describe how far the experiment has been developed. When the expert encounters any difficulty in experiment, he can consult with the purchaser by describing in the experimental information table what experimental difficulty he has encountered.

In the course of experiment the expert logs the development of experiment by filling the blank titled “development of experiment” in the table, thereby permitting PPP to realize how far the experiment has been developed. If some difficulties should be encountered, the expert and the purchaser can discuss and recheck the manner of effecting the experiment. If development of the experiment should be behind the schedule, and if the experiment should be supposed to be unfinished as scheduled, the expert can ask the purchaser to agree with postponement.

If some difficulties should be encountered in the course of experiment, the expert writes in the blank titled “problems”, and then, the purchaser can understand what problems prevent further development of the experiment. The purchaser can suggest any idea of solving such problems by writing in the blank with the aid of the personal computer 11.

Thus, the experiment can be performed, allowing the purchaser to joint in the experiment when occasions demand. When the experiment has been finished, the expert writes in the blank titled “experiment finish and report on experimental results”, describing completion of the required experiment and the results of the experiment, as for instance follows: the type and size of the cutting tool most appropriate for dicing CSP substrates is identified; the machining water supplying rate per unit time is determined and such like.

The expert has a lot of experimental records, on the basis of which he reports the experimental results. He can attach such experimental records to the table. These may be photographs showing the diced CSP substrates, data and or graphs showing the rejection rates and others. These extra pieces of information can be stored on the side of the server, so that the purchaser can have such data presented on the monitor display of the personal computer 11.

When the purchaser is satisfied with the results of the experiment as shown on the monitor display, the expert can finish the experiment, and he prepares a written report of the experiment, which is mailed to the purchaser later.

As may be understood from the above, the manufacturer and the purchaser can discuss about the experiment while being carried out, so that the purchaser may be satisfied with the results of the experiment when completed.

Telephone lines or exclusive communication lines may be used in place of the Internet. In such cases, data pertaining to the experiment is stored preferably on manufacturer's side, allowing the purchaser to access to the so stored data. The terminal devices may be mobile phones.

As may be understood from the above, an experimental information exchanging system according to the present invention permits the manufacturer and the purchaser to have update pieces of experimental information in common. They can check the development of experiment on the way to the finish, discussing about the manner of practicing the experiment to reach their agreement while watching their monitor displays. Even if the manufacturer should have any wrong idea in practicing the experiment, the purchaser can correct their idea immediately, thus leading the manufacturer to follow the right course.

Logging the table is convenient to gain purchaser's better understanding as to how far the experiment has been developed, and the manufacturer can consult with the purchaser as to how the difficulties encountered can be reduced. If the circumstances should compel the manufacturer to change the schedule, they can propose the revised schedule for purchaser's approval.

What is claimed is:

1. An experimental information exchanging system using terminal devices connected to a computer communication system permitting a purchaser and a manufacturer to exchange the experimental information, characterized in that the experimental information includes at least experimental contents, preparation items required for a given experiment and pieces of information pertaining to development of the experiment; and that the experimental information is presented on each monitor display of the terminal devices, thereby permitting the purchaser and the manufacturer to discuss on the experiment on the basis of the experimental information presented on the each display of the terminal devices.

2. An experimental information exchanging system according to claim 1, wherein the experimental information presented on the monitor display includes, in the form of titled blanks, name of the purchaser, name of the manufacturer, date on which the purchaser asked the manufacturer to carry out a required experiment, theme of the experiment, date on which the experiment is scheduled to start or the experiment is made to start, date on which the experiment is scheduled to end or the experiment is finished, a table of experiment schedule, problems to be solved, a method of solving such problems and a report on the experimental development; and the purchaser or the manufacturer writes in selected blanks, and reads out required pieces of information from so filled blanks, thereby permitting the purchaser or manufacturer to make a required confirmation on the monitor display.

3. An experimental information exchanging system according to claim 1, wherein photographs, drawings and/or experimental data are attached to the experimental information.

4. An experimental information exchanging system according to claim 1, wherein the computer communication system is an Internet, and the experimental information is stored in a server.
